(19) United States
(12) Patent Application Publication
(10) Pub. No.: US 2012/0226403 A1
(43) Pub. Date: Sep. 6, 2012

(54) CONTROLLER AND CONTROL METHOD FOR VEHICLE

(75) Inventors: Masaya YAMAMOTO, Kasugai-shi (JP); Masashi FUNADA, Obu-shi (JP)

(73) Assignees: DENSO CORPORATION, Kariya-City (JP); TOYOTA JIDOSHA KABUSHIKI KAISHA, Toyota-shi (JP)

(21) Appl. No.: 13/411,023

(22) Filed: Mar. 2, 2012

(30) Foreign Application Priority Data
Mar. 3, 2011 (JP) 2011-046332

(51) Int. Cl. B60W 20/00; B60W 10/08; B60W 10/06

(52) U.S. Cl. 701/22; 903/930

(57) ABSTRACT

A controller for a vehicle including an engine and a motor includes: a setting section that sets a command power based on a required power required by a user; and a control section that controls the engine and the motor so as to stop the engine and achieve the command power by using the motor before an engine starting condition is satisfied, and so as to start the engine and achieve the command power by using the engine and the motor after the engine starting condition is satisfied. The setting section changes the command power, at any point in time during a transition period from when the engine starting condition is satisfied to when the engine is started, so as to approach a value corresponding to the driving power, if a difference between the command power and the driving power is occurring or expected to occur during the transition period.

### INCORPORATION BY REFERENCE

The disclosure of Japanese Patent Application No. 2011-046332 filed on Mar. 3, 2011 including the specification, drawings and abstract is incorporated herein by reference in its entirety.

### BACKGROUND OF THE INVENTION

1. Field of the Invention

The invention relates to a controller and a control method for a vehicle including an engine and a motor.

2. Description of Related Art Japanese Patent Application Publication No. 2004-282852 (JP-A-2004-282852) describes a hybrid vehicle that determines the target toque of the engine by placing limitations on the torque required by the user, and determines the assist torque of the motor in accordance with the difference between the required torque and the actual torque of the engine. In cases where the torque transmitted to the axle changes abruptly, such as when changing the speed of the engine or starting the vehicle, this hybrid vehicle is configured to control the actual torque so that the user obtains closer feeling to that when torque required by the user is generated, by relaxing the limitations on the required torque.

Incidentally, hybrid vehicles are configured to switch between driving using the power of the motor without using the power of the engine (hereinafter also referred to as “EV driving”) and driving using the power of both the engine and the motor (hereinafter also referred to as “HV driving”). When making a transition from EV driving to HV driving by starting the engine in the hybrid vehicles, if there is a difference between the command torque and the actual torque, abrupt changes in acceleration occur, causing the user discomfort in some cases. In JP-A-2004-282852, no consideration is given as to how to address such a problem.

### SUMMARY OF THE INVENTION

The invention provides a controller and a control method for a vehicle including an engine and a motor, which reduce abrupt changes in acceleration when starting the engine.

A first aspect of the invention relates to a controller for a vehicle including an engine and a motor. The controller includes a setting section that sets a command power that is a command value for the driving power of the vehicle, on the basis of a required power required by a user, and a control section that controls the engine and the motor so as to stop the engine and achieve the command power by using the motor before an engine starting condition is satisfied, and controls the engine and the motor so as to start the engine and achieve the command power by using the engine and the motor after the engine starting condition is satisfied. The setting section changes the command power, at any point in time during a transition period from when the engine starting condition is satisfied to when the engine is started, so as to approach a value corresponding to the driving power, if a difference between the command power and the driving power is occurring or if the difference is expected to occur during the transition period.

The output power of the motor may be limited to be less than or equal to a first value. The engine starting condition may be that the required power has reached a second value that is larger than the first value by a predetermined value. The setting section may change the command power so as to approach the value corresponding to the driving power, at the time when the engine starting condition is satisfied.

The setting section may decrease the command power from a value corresponding to the required power to a value corresponding to an actual driving power, at the time when the required power has reached the second value, and the setting section may increase the command value so as to approach the required power while limiting a rate of increase of the command power to be less than or equal to a predetermined rate of increase, after decreasing the command power to the value corresponding to the actual driving power.

The setting section may include a first processing section that sets a reference power, and a second processing section that changes the command power so as to approach the required power while limiting the rate of change of the command power with respect to the reference power to be less than or equal to a predetermined rate of change. The first processing section may set the reference power to a value based on the history of the command power, if the required power has not reached the second value, and the first processing section may change the reference power from the value based on the history of the command power to a value based on a history of an actual driving power, if the required power has reached the second value.

The vehicle may include an electric power storage device that stores electric power to be supplied to the motor. The output of the electric power storage device may be limited to be less than or equal to a limit value. The first value may be a value corresponding to the limit value.

The vehicle may include a generator connected to the engine, the generator being configured to perform cranking of the engine by generating electric power. The control section may cause the generator to generate electric power so as to perform the cranking if the engine starting condition is satisfied. The controller may further include a limit value setting section that decreases the limit value by a value corresponding to the amount of electric power generated in the generator for the cranking.

A second aspect of the invention relates to a control method for a vehicle including an engine and a motor. The control method includes: setting a command power that is a command value for the driving power of the vehicle, on the basis of a required power required by a user; controlling the engine and the motor so as to stop the engine and achieve the command power by using the motor before an engine starting condition is satisfied, and controlling the engine and the motor so as to start the engine and achieve the command power by using the engine and the motor after the engine starting condition is satisfied; and changing the command power, at any point in time during a transition period from when the engine starting condition is satisfied to when the engine is started, so as to approach a value corresponding to the driving power if a difference between the command power and the driving power is occurring or if the difference is expected to occur during the transition period.

According to the above-mentioned configuration, in a vehicle including an engine and a motor, abrupt changes in acceleration when starting the engine can be reduced.

### BRIEF DESCRIPTION OF THE DRAWINGS

Features, advantages, and technical and industrial significance of exemplary embodiments of the invention will be described below with respect to the accompanying drawings, in which like numerals denote like elements, and wherein:

FIG. 1 is a general block diagram of a vehicle;

FIG. 2 is a collinear diagram that illustrates a state during HV driving;

FIG. 3 is a collinear diagram that illustrates a state during EV driving;

FIG. 4 is a collinear diagram that illustrates a state during transition from EV driving to HV driving;

FIG. 5 schematically illustrates cranking torque Tcrk;

FIG. 6 is a functional block diagram of an ECU according to a first embodiment;

FIG. 7 is a flowchart that illustrates processing steps in the ECU according to the first embodiment;

FIG. 8 is a flowchart that illustrates processing steps in the ECU according to the first embodiment;

FIG. 9 illustrates how required power Preq, command power Pcom, and actual driving power Pact change in a case where a conventional ECU according to the related art is used;

FIG. 10 illustrates how required power Preq, command power Pcom, and actual driving power Pact change in a case where the ECU according to the first embodiment is used;

FIG. 11 is a functional block diagram of an ECU according to a second embodiment;

FIG. 12 is a flowchart that illustrates processing steps in the ECU according to the second embodiment; and

FIG. 13 illustrates how required power Preq, command power Pcom, and actual driving power Pact change in a case where the ECU according to the second embodiment is used.

### DETAILED DESCRIPTION OF EMBODIMENTS

Hereinafter, embodiments of the invention are described in detail with respect to the drawings. Like or equivalent portions in the drawings are denoted by the same reference numerals, and a description of such portions is not repeated.

### First Embodiment

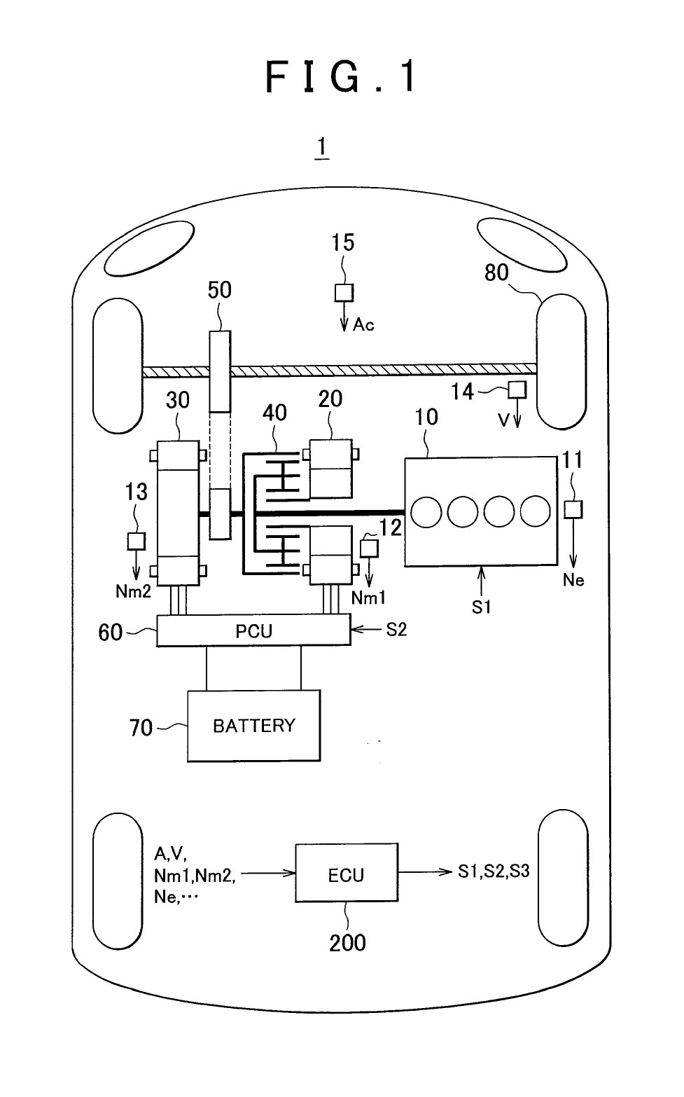

FIG. 1 is a general block diagram of a vehicle 1 according to a first embodiment of the invention. As illustrated in FIG. 1, the vehicle 1 includes an engine 10, a first motor generator (MG) 20, a second MG 30, a power splitter 40, a reducer 50, a power control unit (PCU) 60, a battery 70, drive wheels 80, and an electronic control unit (ECU) 200.

The engine 10, the first MG 20, and the second MG 30 are connected to each other via the power splitter 40. The vehicle 1 is driven by the driving force outputted from at least one of the engine 10 and the second MG 30. Power generated by the engine 10 is split into two paths by the power splitter 40. One of the two paths is a path along which the power is transmitted to the drive wheels 80 via the reducer 50, and the other is a path along which the power is transmitted to the first MG 20.

The engine 10 is controlled by a control signal S1 from the ECU 200. The first MG 20 and the second MG 30 are each an AC motor, for example, a three-phase AC synchronous motor. The first MG 20 generates electric power by using the power of the engine 10 split by the power splitter 40. The second MG 30 generates driving force by using at least one of electric power stored in the battery 70 and electric power generated by the first MG 20. The driving force of the second MG 30 is transmitted to the drive wheels 80 via the reducer 50. During braking of the vehicle or the like, the second MG 30 is driven by the drive wheels 80 via the reducer 50, and the second MG 30 acts as a generator. Thus, the second MG 30 also functions as a regenerative brake that converts the kinetic energy of the vehicle into electric power. The regenerative electric power generated by the second MG 30 is stored into the battery 70.

The power splitter 40 is made up of a planetary gear including a sun gear, a pinion gear, a carrier, and a ring gear. The pinion gear engages the sun gear and the ring gear. The carrier supports the pinion gear in a manner that allows the pinion gear to rotate on its own axis, and is connected to the crankshaft of the engine 10. The sun gear is connected to the rotating shaft of the first MG 20. The ring gear is connected to the rotating shaft of the second MG 30 and the reducer 50. In this way, as the engine 10, the first MG 20, and the second MG 30 are connected via the power splitter 40 made up of a planetary gear, the relationship between engine speed Ne, first-MG rotational speed (the rotational speed of the rotating shaft of the first MG 20) Nm1, and second-MG rotational speed (the rotational speed of the rotating shaft of the second MG 30) Nm2 is such that these values are connected by a straight line on a collinear diagram.

The PCU 60 is controlled by a control signal S2 from the ECU 200. The PCU 60 converts DC power stored in the battery 70 into AC power that can drive the first MG 20 and the second MG 30, and outputs the AC power to the first MG 20 and/or the second MG 30. Thus, the electric power stored in the battery 70 drives the first MG 20 and/or the second MG 30. Also, the PCU 60 converts AC power generated by the first MG 20 and/or the second MG 30 into DC power that can be changed into the battery 70, and outputs the DC power to the battery 70. Thus, the battery 70 is charged by the electric power generated by the first MG 20 and/or the second MG 30.

The battery 70 is a DC power supply that stores the electric power for driving the first MG 20 and/or the second MG 30. The battery 70 is, for example, a secondary battery such as a nickel hydrogen battery or a lithium ion battery. The voltage of the battery 70 is, for example, about 200 V. As the battery 70, it is also possible to adopt a large-capacitance capacitor.

The ECU 200 is connected with a rotational speed sensor 11, resolvers 12 and 13, a vehicle speed sensor 14, an accelerator position sensor 15, and the like.

The rotational speed sensor 11 detects the engine speed (the rotational speed of the crankshaft of the engine 10) Ne. The resolver 12 detects the first-MG rotational speed Nm1. The resolver 13 detects the second-MG rotational speed Nm2. The vehicle speed sensor 14 detects a vehicle speed V from the rotational speed of the drive shaft. The accelerator position sensor 15 detects the amount of operation Ac on the accelerator pedal by the user. Each of these sensors transmits a signal indicative of the detection result to the ECU 200.

The ECU 200 incorporates a central processing unit (CPU) and a memory, both of which are not illustrated. The ECU 200 is configured to execute predetermined computation processing on the basis of information stored in the memory or information from each of the sensors.

The vehicle 1 is driven in one of an electric vehicle driving mode (hereinafter also referred to as “EV driving mode”) and a hybrid vehicle driving mode (hereinafter also referred to as “HV driving mode”). The EV driving mode is a mode in which the engine 10 is stopped, and the vehicle 1 is driven by the power of the second MG 30. The HV driving mode is a mode in which the engine 10 is started, and the vehicle 1 is driven by the power of both the engine 10 and the second MG 30.

The ECU 200 controls the engine 10, the first MG 20, and the second MG 30 so as to drive the vehicle 1 in one of the EV driving mode and the HV driving mode. In the following description, the torque of the engine 10 is represented as “engine torque Te”, the torque of the first MG 20 is represented as “first-MG torque Tm1”, and the torque of the second MG 30 is represented as “second-MG torque Tm2”.

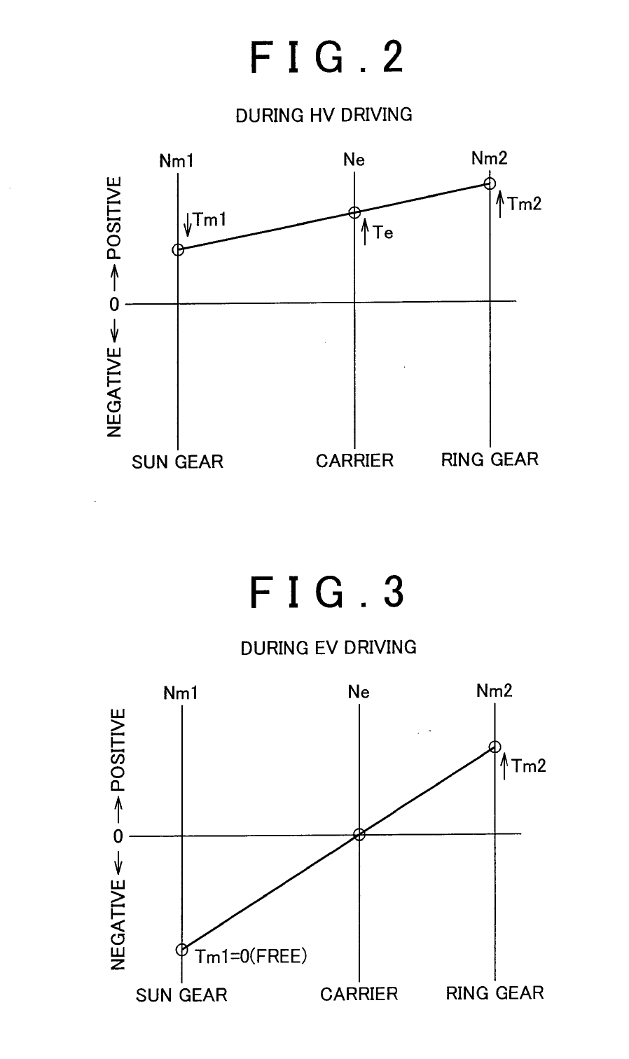

FIGS. 2 to 4 each illustrate the states of the engine 10, first MG 20, and second MG 30 controlled by the ECU 200 as represented on a collinear diagram. As described above, the relationship between engine speed Ne, first-MG rotational speed Nm1, and second-MG rotational speed Nm2 is such that these values are connected by a straight line on the collinear diagram.

FIG. 2 is a collinear diagram that illustrates a state during HV driving. During HV driving, the ECU 200 controls the engine torque Te and the second-MG torque Tm2 so that the power required by the user is achieved by the power of both the engine 10 and the second MG 30. At this time, the ECU 200 feedback-controls the first-MG torque Tm1 so that the first-MG torque Tm1 bears the reaction forces of the engine torque Te and second-MG torque Tm2.

FIG. 3 is a collinear diagram that illustrates a state during EV driving. During EV driving, the ECU 200 stops the engine 10 (sets the engine speed Ne=0), and controls the second-MG torque Tm2 so as to achieve the power requested by the user by the power of the second MG 30. At this time, the ECU 200 sets the first MG 20 to, for example, free (sets Tm1=0).

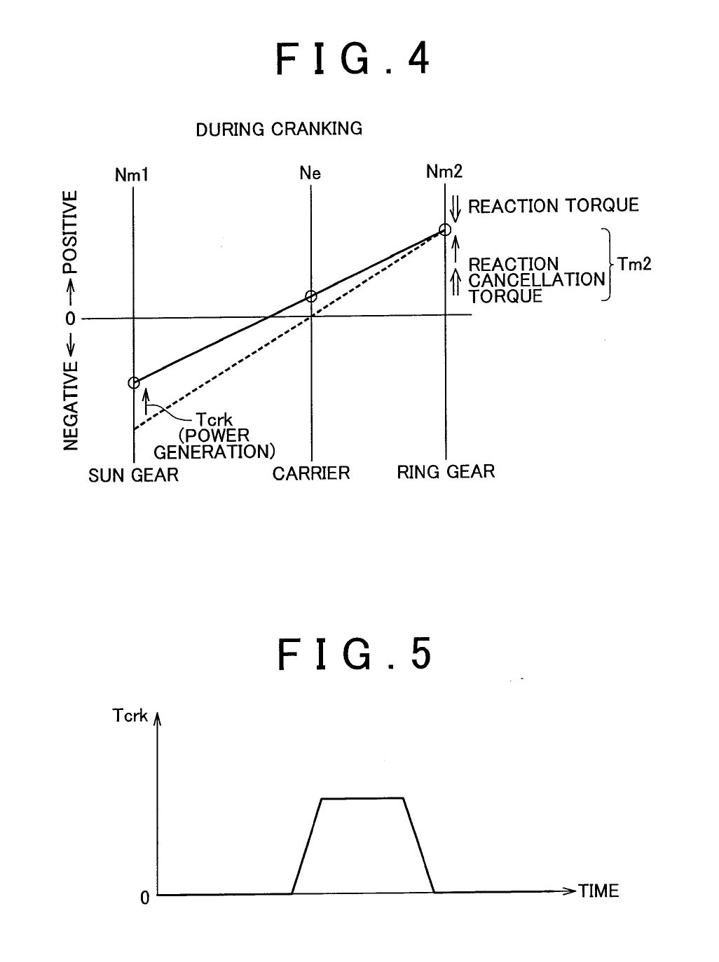

FIG. 4 is a collinear diagram that illustrates a state during transition from EV driving to HV driving. When the driving mode transitions from EV driving to HV driving, the ECU 200 cranks the engine by using the first MG 20. That is, as illustrated in FIG. 4, the ECU 200 causes a positive cranking torque Tcrk to be generated from the first MG 20 (sets Tm1=Tcrk). At this time, the ECU 200 increases the second-MG torque Tm2 by an amount equivalent to the reaction cancellation torque for cancelling out the reaction torque generated by the cranking torque Tcrk.

The ECU 200 starts ignition control of the engine 10 when the engine speed Ne has risen to a predetermined speed due to the cranking torque Tcrk. When combustion by this ignition control (so-called first fire) is performed, the engine 10 is started, thus completing the transition from EV driving to HV driving.

FIG. 5 schematically illustrates cranking torque Tcrk. When the vehicle 1 is moving forwards in the EV driving mode (when Ne=0 and Nm2>0), the first MG 20 is rotating in the negative direction (Nm1<0). To generate a positive torque from the first MG 20 during the negative rotation of the first MG 20, it is necessary to cause the first MG 20 to generate electric power. Thus, the ECU 200 causes the first MG 20 to generate a cranking power ΔP1crk (>0) for generating the cranking torque Tcrk.

As described above, during cranking, the second-MG torque Tm2 needs to be increased by an amount equivalent to the reaction cancellation torque. Letting the power consumed by the second MG 30 to generate this reaction cancellation torque be reaction cancellation power ΔPcancel (>0), the actual amount of electric power ΔPcrk generated during cranking is represented as ΔPcrk=ΔP1crk−ΔPcancel, supposing that the case where ΔPcrk>0 is defined as when electric power is being generated.

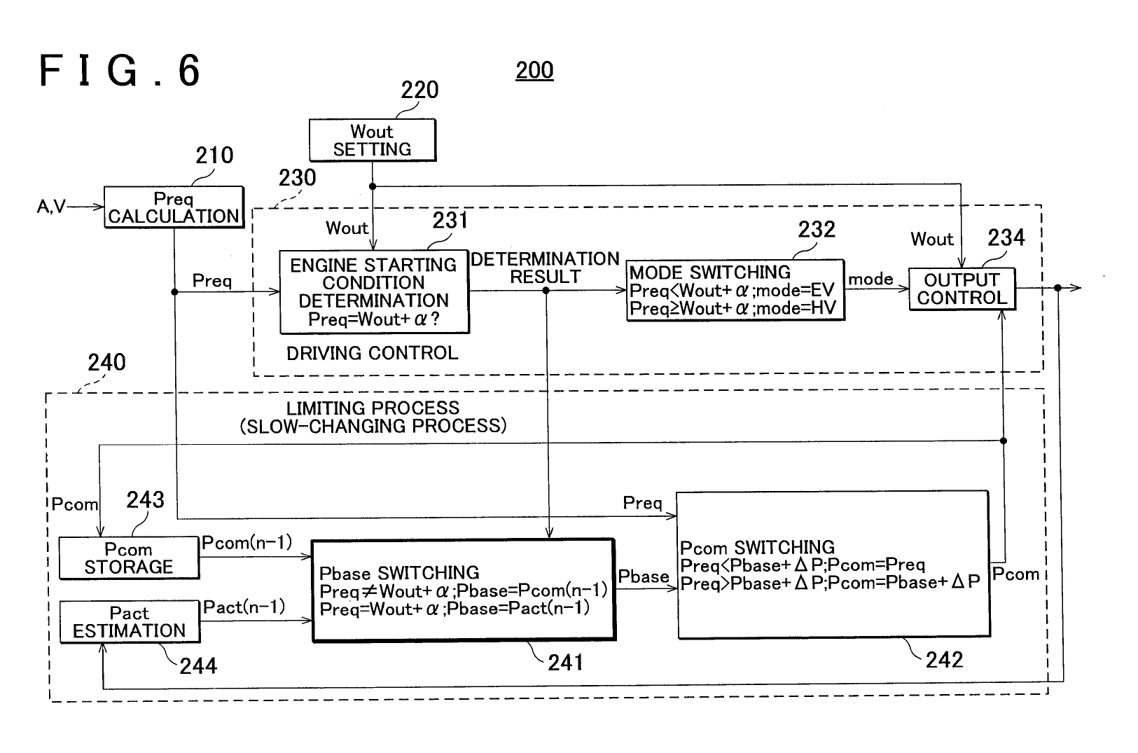

FIG. 6 is a functional block diagram of the ECU 200. The functional blocks illustrated in FIG. 6 may be either implemented by hardware or implemented by software.

The ECU 200 includes a calculation section 210, a first setting section 220, a driving control section 230, and a second setting section 240.

The calculation section 210 calculates the driving power of the vehicle 1 required by the user (hereinafter also referred to as “required power Preq”), on the basis of the amount of operation Ac on the accelerator pedal by the user and the vehicle speed V. For example, the calculation section 210 obtains the required torque Treq corresponding to the amount of operation Ac on the accelerator pedal and the vehicle speed V, and calculates the required power Preq corresponding to the required torque Treq and the vehicle speed V. While the following description is mainly directed to control of “power” for the convenience of description, “torque” may be controlled instead of “power”.

The first setting section 220 sets the battery output limit value Wout in accordance with the temperature of the battery 70, or the like. As described later, the actual output power of the battery 70 (hereinafter, referred to as “actual battery power Pb”) is limited to be less than the battery output limit value Wout. Thus, degradation of the battery 70 is reduced, and the life of the battery 70 is prolonged.

Next, the driving control section 230 is described. The driving control section 230 includes a condition determining section 231, a mode switching section 231, and an output control section 234.

The condition determining section 231 determines whether an engine starting condition has been satisfied, on the basis of the required power Preq and the battery output limit value Wout. The condition determining section 231 determines that an engine starting condition has been satisfied when the required power Preq reaches a value equal to the battery output limit value Wout plus a predetermined value α (when Preq=Wout+α). In this way, the engine starting condition is determined to have been satisfied when the required power Preq reaches not the “battery output limit value Wout” but the “battery output limit value Wout+predetermined value α”, thereby extending the operating range in which EV driving is continued (hereinafter, referred to as “EV driving range”).

The mode switching section 232 sets the driving mode to the EV driving mode, if the engine starting condition has not been satisfied (if Preq<Wout+α). On the other hand, the mode switching section 232 switches the driving mode from the EV driving mode to the HV driving mode, if the engine starting condition has been satisfied (if Preq≧Wout+α).

The output control section 234 controls the outputs of the engine 10, first MG 20, and second MG 30 so as to achieve the command power Pcom set by the second setting section 240 described later.

During driving in the EV driving mode, the output control section 234 controls the PCU 60 so as to achieve the command power Pcom by the output power of the second MG 30.

During driving in the HV driving mode, the output control section 234 controls the engine 10 and the PCU 60 so as to achieve the command power Pcom by the outputs of the engine 10 and second MG 30.

In either of the driving modes, the output control section 234 limits the actual battery power Pb to be less than the battery output limit value Wout. In the HV driving mode, when the command power Pcom exceeds the battery output limit value Wout, the amount by which the command power Pcom exceeds the battery output limit value Wout can be supplemented by the output of the engine 10. On the other hand, in the EV driving mode, the amount by which the command power Pcom exceeds the battery output limit value Wout cannot be supplemented by the output of the engine 10. Since the output power of the second MG 30 is the sum of the actual battery power Pb and the amount of electric power generated by the first MG 20, in the EV driving mode, unless electric power is generated by the first MG 20, the actual driving power of the vehicle 1 (hereinafter, referred to as “actual driving power Pact”) is substantially limited to be less than the battery output limit value Wout.

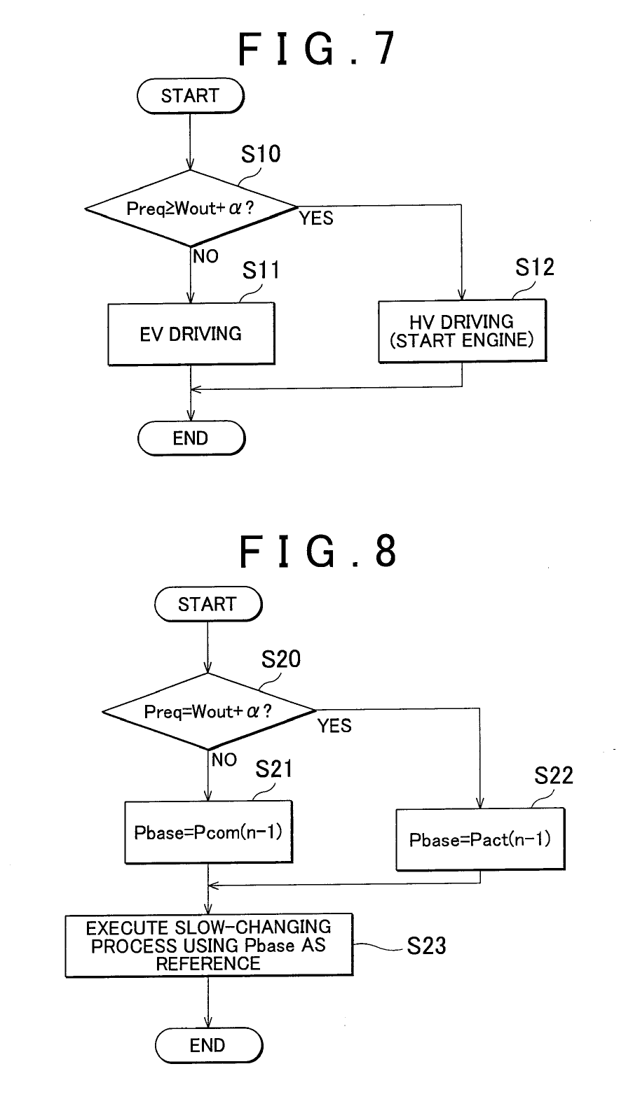

FIG. 7 is a flowchart that illustrates processing steps in the ECU 200 for achieving the function of the driving control section 230. The flowchart illustrated in FIG. 7 is executed repeatedly at a predetermined cycle.

In step (hereinafter, step is abbreviated as “S”) 10, the ECU 200 determines whether the engine starting condition has been satisfied, specifically, whether Preq≧Wout+α.

If the engine starting condition has not been satisfied, that is, if Preq<Wout+α (S10; NO), the ECU 200 transfers the processing to S11, and performs EV driving.

On the other hand, if the engine starting condition has been satisfied, that is, if Preq≧Wout+α (S10; YES), the ECU 200 transfers the processing to S12, and performs HV driving. At this time, if EV driving had been performed in the previous cycle (that is, when the driving mode transitions from EV driving to HV driving), as described above, the ECU 200 causes the cranking torque Tcrk to be generated from the first MG 20 (see FIGS. 4 and 5), and when the engine speed Ne has risen to a predetermined speed, the ECU 200 starts ignition control of the engine 10 to start the engine 10.

Returning to FIG. 6, next, the second setting section 240 is described. The second setting section 240 sets the command power Pcom on the basis of the required power Preq, and outputs the set command power Pcom to the output control section 234. At this lime, the second setting section 240 performs a process whereby the command power Pcom is changed slowly by limiting the amount of change of the command power Pcom per unit time to be less than or equal to a predetermined amount of change (hereinafter, referred to as “slow-changing process”).

The second setting section 240 includes a reference power setting section 241, a command power setting section 242, a storage section 243, and an estimation section 244.

The reference power setting section 241 switches the value that serves as a reference for the slow-changing process (hereinafter, referred to as “reference power Pbase”) depending on whether the engine starting condition is currently satisfied. If the engine starting condition is not currently satisfied (if Preq≠Wout+α), the reference power setting section 241 sets the reference power Pbase to the command power Pcom stored into the storage section 243 in the previous cycle (hereinafter, referred to as “previous command power value Pcom (n−1)”). On the other hand, if the engine starting condition is currently satisfied (if Preq=Wout+α), the reference power setting section 241 sets the reference power Pbase to the actual driving power Pact estimated by the estimation section 244 in the previous cycle (hereinafter, referred to as “previous actual driving power value Pact (n−1)”). Although the reference power setting section 241 normally sets the reference power Pbase to the previous command power value Pcom (n−1), the reference power setting section 241 has the function of switching the reference power Pbase from the previous command power value Pcom (n−1) to the previous actual driving power value Pact (n−1) at the time when the engine starting condition is satisfied.

The command power setting section 242 sets the command power Pcom on the basis of the required power Preq calculated by the calculation section 210. At this time, the command power setting section 242 performs the slow-changing process mentioned above. Specifically, the command power setting section 242 limits the amount of increase of the command power Pcom with respect to the reference power Pbase (=Pcom−Pbase) so as not to exceed a predetermined value ΔP (>0). More specifically, if the required power Preq is smaller than a value equal to the reference power Pbase plus the predetermined value ΔP (if Preq<Pbase+ΔP), the command power setting section 242 sets the command power Pcom to the required power Preq (sets Pcom=Preq). On the other hand, if the required power Preq is larger than the value equal to the reference power Pbase plus the predetermined value ΔP (if Preq>Pbase+ΔP), the command power setting section 242 does not set the command power Pcom to the required power Preq, but to a value equal to the reference power Pbase plus the predetermined value ΔP (sets Pcom=Pbase+ΔP).

The storage section 243 stores the command power Pcom set by the command power setting section 242. The estimation section 244 estimates the actual driving power Pact on the basis of a control signal or the like outputted from the output control section 234 to the engine 10 or the PCU 60. The method of estimating the actual driving power Pact is not limited to this, and the actual driving power Pact may be estimated by using other methods. The estimation section 244 stores the estimated actual driving power Pact.

FIG. 8 is a flowchart that illustrates processing steps in the ECU 200 for achieving the function of the second setting section 240.

In S20, the ECU 200 determines whether the engine starting condition is currently satisfied, specifically, whether Preq=Wout+α.

If the engine starting condition is not currently satisfied, that is, if Preq≠Wout+α (S20; NO), the ECU 200 transfers the processing to S21, and sets the reference power Pbase to the previous command power value Pcom (n−1). On the other hand, if the engine starting condition is currently satisfied, that is, if Preq=Wout+α (S20; YES), the ECU 200 transfers the processing to S22, and sets the reference power Pbase to the previous actual driving power value Pact (n−1).

In S23, the ECU 200 performs the slow-changing process mentioned above using the reference power Pbase set in S21 or S22 as a reference.

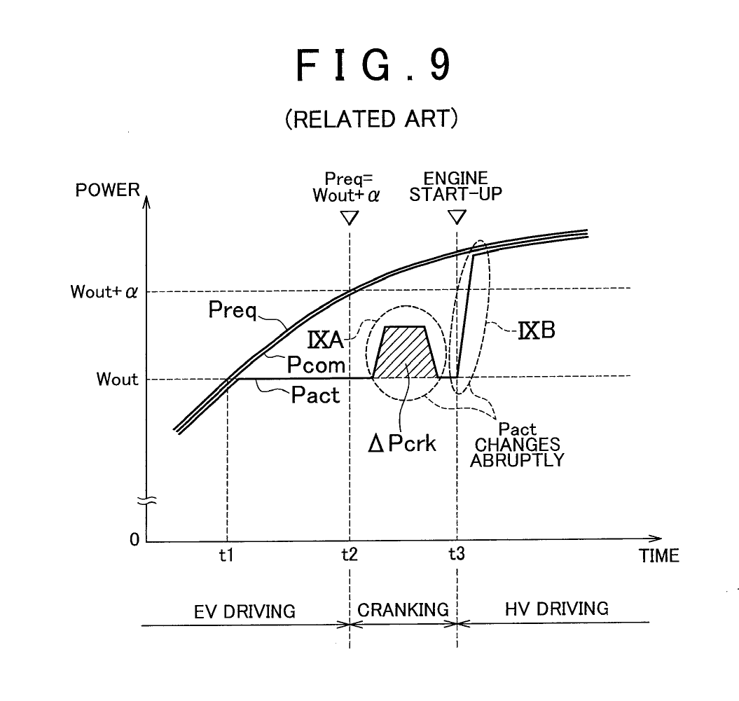

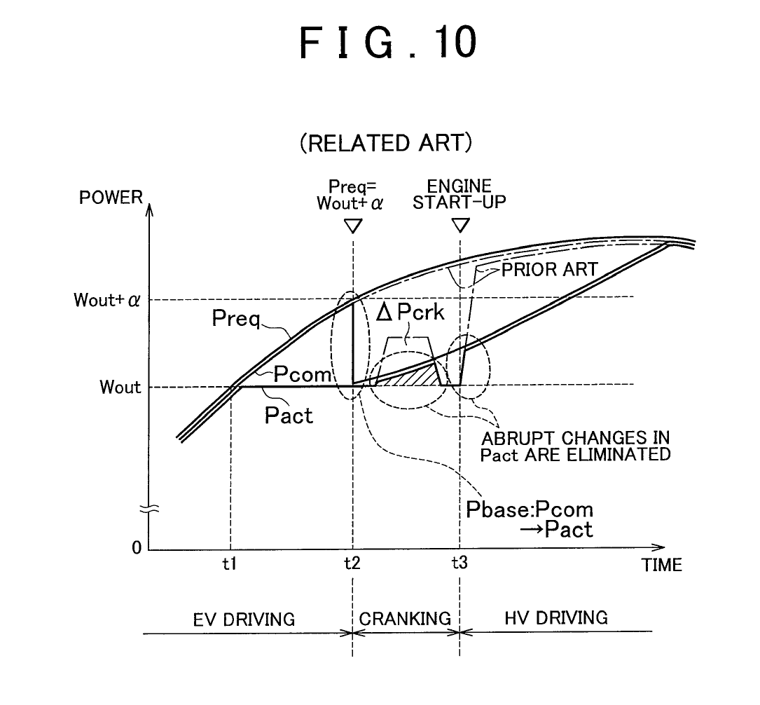

FIG. 9 illustrates how required power Preq, command power Pcom, and actual driving power Pact change in a case where an ECU according to the related art (an ECU that does not have the function of the reference power setting section 241 mentioned above) is used. In FIG. 9, until time t2, EV driving is performed because Preq<Wout+α.

During EV driving, as described above, unless electric power is generated by the first MG 20, the actual driving power Pact is substantially limited to be less than the battery output limit value Wout. As a result, in the period from time t1 to time t2 during which the required power Preq exceeds the battery output limit value Wout, the actual driving power Pact is limited to the battery output limit value Wout, and thus a difference occurs between the command power Pcom and the actual driving power Pact.

When Preq becomes equal to Wout+α at time t2, cranking is performed, and an electric power ΔPcrk is generated. An amount of the generated electric power ΔPcrk corresponds to the cranking torque Tcrk. The generated electric power ΔPcrk is supplied to the second MG 30 to increase or decrease the output power of the second MG 30. In the related art, the state in which there is a difference between the command power Pcom and the actual driving power Pact continues even during the cranking period from time t2 to t3. Consequently, the actual driving power Pact is also increased or decreased in accordance with the generated electric power ΔPcrk, resulting in abrupt changes in acceleration, which cause the user discomfort (see the portion IXA in FIG. 9).

After the engine 10 is started by ignition at time t3, as the actual driving power Pact abruptly increases to become the command power Pcom due to the engine power Pe, abrupt changes in acceleration occur, causing the user discomfort (see the portion IXB in FIG. 9).

FIG. 10 illustrates how required power Preq, command power Pcom, and actual driving power Pact change in a case where the ECU 200 according to this embodiment is used.

In this embodiment, to overcome the problem described above with respect to FIG. 9, at time t2 when the engine starting condition is satisfied, the reference power Pbase that serves as a reference for the slow-changing process of the command power Pcom is switched from the previous command power value Pcom (n−1) to the previous actual driving power value Pact (n−1). That is, at the time when the engine starting condition is satisfied, the reference for the slow-changing process of the command power Pcom is changed from a value equivalent to the command power to a value equivalent to the actual power, and the slow-changing process is performed all over again from the value equivalent to the actual power. Thus, the difference between the command power Pcom and the actual driving power Pact is eliminated at time t2, thereby making it possible to eliminate abrupt changes in actual driving power Pact as illustrated in the portion IXA or the portion IXB in FIG. 9 in the subsequent cranking period or when starting the engine.

As described above, it is expected that due to factors such as extended EV driving range, a difference will occur between the command power Pcom and the actual driving power Pact during the transition period from EV driving to HV driving. For this reason, the ECU 200 according to this embodiment changes the command power Pcom so as to approach the actual driving power Pact at the time when the engine starting condition is satisfied. In other words, the ECU 200 changes the command Pcom so that a difference between the command power Pcom and the actual driving power Pact recues. This reduces the difference between the command power Pcom and the actual driving power Pact during the transition period from EV driving to HV driving, thereby reducing abrupt changes in actual driving power Pact occurring due to cranking or engine start-up. As a result, the shock or changes in acceleration transmitted to the driver when starting the engine can be reduced to thereby mitigate discomfort.

This embodiment may be changed as follows, for example. Due to extended EV driving range, a predetermined value a of difference already exists between the command power Pcom and the actual driving power Pact at the time when the engine starting condition is satisfied. For this reason, in this embodiment, the command power Pcom is changed so as to approach the actual driving power Pact at the time when the engine starting condition is satisfied. However, the invention is not limited to this embodiment. That is, it suffices that the command power Pcom be changed so as to approach the actual driving power Pact at any point in period from when the engine starting condition is satisfied to when the engine is started, in cases where a difference is occurring or is expected to occur between the command power Pcom and the actual driving power Pact during the period from when the engine starting condition is satisfied to when the engine is started. In such cases as well, at least an abrupt increase in actual driving power Pact when starting the engine can be reduced.

While the vehicle 1 described in this embodiment is a normal hybrid vehicle, the invention is particularly useful for so-called plug-in hybrid vehicles for which extended EV driving range is more strongly desired.

### Second Embodiment

In the first embodiment, as illustrated in FIG. 10, there is a possibility of a slight increase or decrease in the actual driving power Pact due to the electric power ΔPcrk generated during cranking.

Accordingly, in this embodiment, the amount of electric power ΔPcrk generated during cranking is temporarily subtracted from the battery output limit value Wout, thereby further reducing an increase or decrease in actual driving power Pact during cranking. Since the structure, function, and processing according to the second embodiment are otherwise the same as those according to the first embodiment mentioned above, a detailed description is not repeated here.

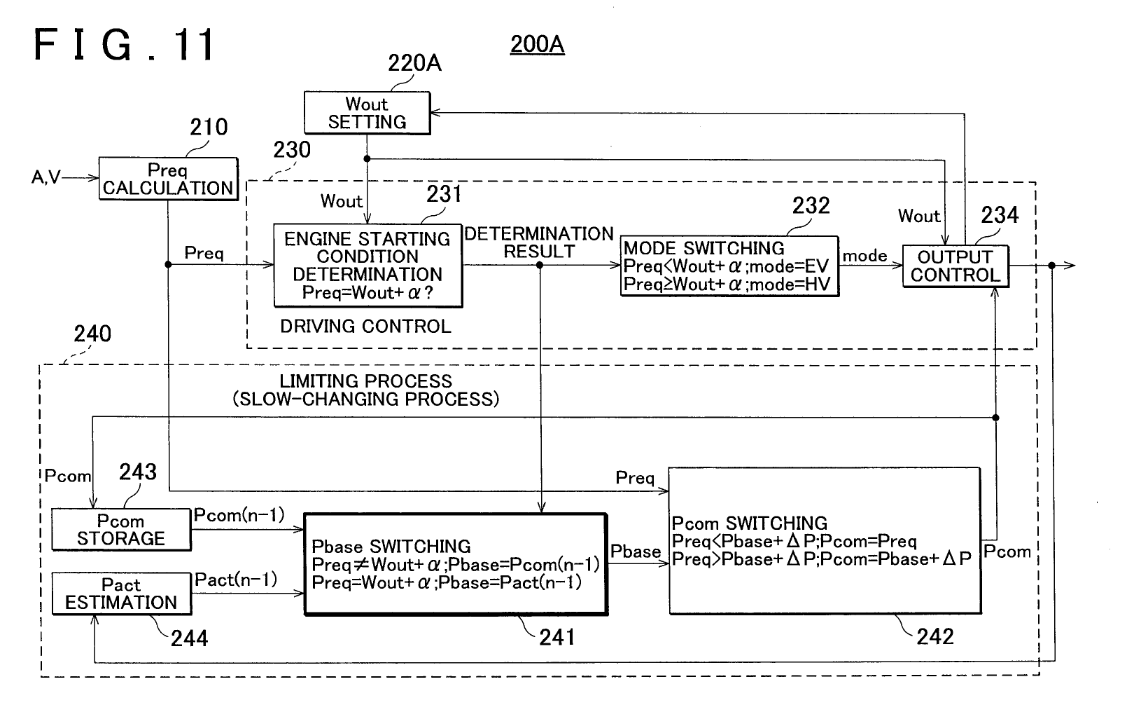

FIG. 11 is a functional block diagram of an ECU 200A according to this embodiment. Of the functional blocks illustrated in FIG. 11, the functional blocks denoted by the same reference numerals as those of the functional blocks illustrated in FIG. 6 mentioned above have already been described, and thus their detailed description is not repeated here.

A third setting section 220A sets the battery output limit value Wout in accordance with the temperature of the battery 70, or the like. Also, the third setting section 220A calculates the amount of electric power ΔPcrk generated during cranking, and corrects the battery output limit value Wout by temporarily subtracting the amount of electric power ΔPcrk generated during cranking from the battery output limit value Wout.

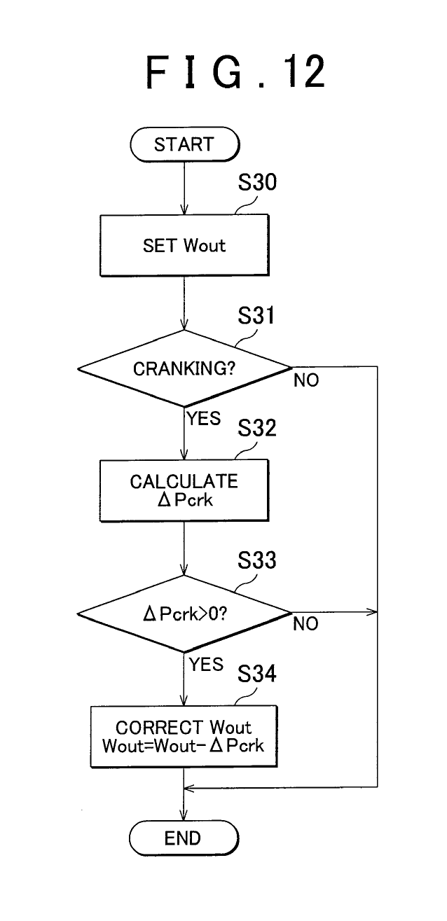

FIG. 12 is a flowchart that illustrates processing steps in the ECU 200A for achieving the function of the third setting section 220A mentioned above.

In S30, the ECU 200A sets the battery output limit value Wout in accordance with the temperature of the battery 70, or the like.

In S31, the ECU 200A determines whether cranking is being currently performed. If cranking is being currently performed (S31; YES), in S32, the ECU 200A calculates the amount of electric power ΔPcrk generated during cranking. Specifically, the ECU 200A obtains the above-mentioned cranking powerΔP1crk and reaction cancellation power ΔPcancel, and subtracts the reaction cancellation power ΔPcancel from the cranking power ΔP1crk to obtain the amount of electric power ΔPcrk generated during cranking. Therefore, if the power ΔP1crk (>0) generated by the first MG 20 in order to generate the cranking torque Tcrk is larger than the power ΔPcancel (>0) consumed by the second MG 30 in order to generate the reaction cancellation torque, the amount of electric power ΔPcrk generated during cranking becomes positive.

In S33, the ECU 200A determines whether the calculated amount of generated electric power ΔPcrk is positive, that is, whether the power ΔP1crk (>0) generated by the first MG 20 is larger than the power ΔPcancel (>0) consumed by the second MG 30.

If ΔPcrk>0 (S33; YES), in S34, the ECU 200A corrects the battery output limit value Wout by subtracting the amount of generated electric power ΔPcrk from the battery output limit value Wout set in the processing of S30.

On the other hand, if cranking is not being currently performed (S31; NO), and if Pcrk<0 (S33; NO), the ECU 200A ends the processing without correcting the battery output limit value Wout.

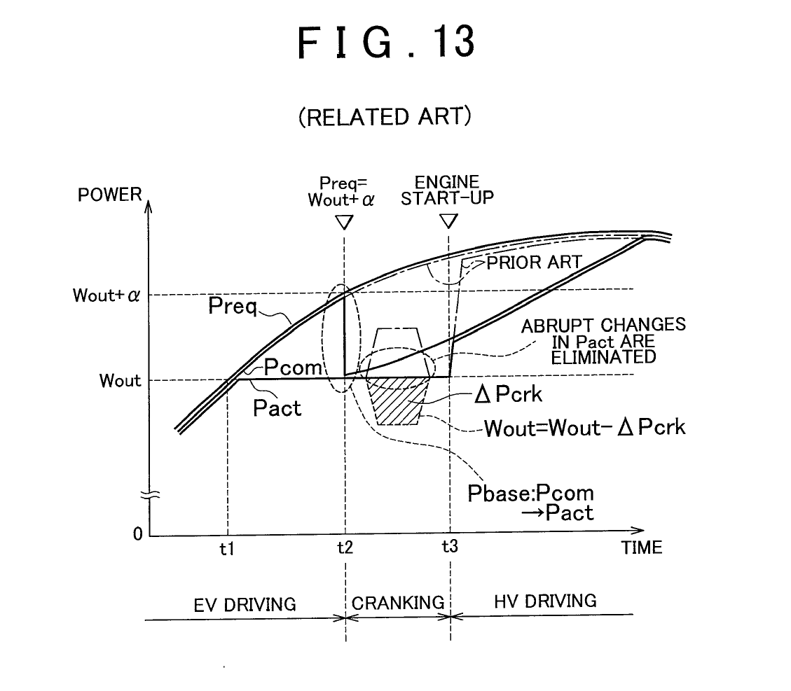

FIG. 13 illustrates how required power Preq, command power Pcom, and actual driving power Pact change in a case where the ECU 200A according to this embodiment is used.

As illustrated in FIG. 13, in this embodiment, as in the first embodiment, at time 12 when the engine starting condition is satisfied, the reference power Pbase that serves as a reference for the slow-changing process of the command power Pcom is switched from the previous command power value Pcom (n−1) to the previous actual driving power value Pact (n−1). Thus, the difference between the command power Pcom and the actual driving power Pact is eliminated at time t2.

Furthermore, in this embodiment, during the cranking period from time t2 to time t3, the amount of electric power ΔPcrk generated during cranking is temporarily subtracted from the battery output limit value Wout. Since the output power of the second MG 30 is thus maintained to be in the vicinity of the battery output limit value Wout during the cranking period as well, it is possible to reduce an increase or decrease in actual driving power Pact occurring during cranking.

The disclosed embodiments are to be considered to be illustrative and not restrictive in all respects. The scope of the invention is to be defined not by the foregoing description but by the appended claims, and is intended to cover all such modifications that are equivalent in meaning to and fall within the scope of claims.

What is claimed is:

1. A controller for a vehicle including an engine and a motor, comprising:
a setting section that sets a command power that is a command value for a driving power of the vehicle, on a basis of a required power required by a user; and
a control section that controls the engine and the motor so as to stop the engine and achieve the command power by using the motor before an engine starting condition is satisfied, and controls the engine and the motor so as to start the engine and achieve the command power by using the engine and the motor after the engine starting condition is satisfied, wherein
the setting section changes the command power, at any point in time during a transition period from when the engine starting condition is satisfied to when the engine is started, so as to approach a value corresponding to the driving power, if a difference between the command power and the driving power is occurring or if the difference is expected to occur during the transition period.

2. The controller according to claim 1, wherein
an output power of the motor is limited to be less than or equal to a first value,
the engine starting condition is that the required power has reached a second value that is larger than the first value by a predetermined value, and
the setting section changes the command power so as to approach the value corresponding to the driving power, at a time when the engine starting condition is satisfied.

3. The controller according to claim 2, wherein
the setting section decreases the command power from a value corresponding to the required power to a value corresponding to an actual driving power, at a time when the required power has reached the second value, and
the setting section increases the command value so as to approach the required power while limiting a rate of increase of the command power to be less than or equal to a predetermined rate of increase, after decreasing the command power to the value corresponding to the actual driving power.

4. The controller according to claim 2, wherein
the setting section includes
a first processing section that sets a reference power, and
a second processing section that changes the command power so as to approach the required power while limiting a rate of change of the command power with respect to the reference power to be less than or equal to a predetermined rate of change,
the first processing section sets the reference power to a value based on a history of the command power, if the required power has not reached the second value, and
the first processing section changes the reference power from the value based on the history of the command power to a value based on a history of an actual driving power, if the required power has reached the second value.

5. The controller according to claim 2, wherein
the vehicle includes an electric power storage device that stores electric power to be supplied to the motor,
an output of the electric power storage device is limited to be less than or equal to a limit value, and
the first value is a value corresponding to the limit value.

6. The controller according to claim 5, wherein
the vehicle includes a generator connected to the engine, the generator being configured to perform cranking of the engine by generating electric power,
the control section causes the generator to generate electric power so as to perform the cranking if the engine starting condition is satisfied, and
the controller further comprises a limit value setting section that decreases the limit value by a value corresponding to an amount of electric power generated in the generator for the cranking.

7. The controller according to claim 1, wherein
the setting section changes the command power to a value corresponding to an actual driving power, at any point in time during the transition period.

8. A control method for a vehicle including an engine and a motor, comprising:
setting a command power that is a command value for a driving power of the vehicle, on a basis of a required power required by a user;
controlling the engine and the motor so as to stop the engine and achieve the command power by using the motor before an engine starting condition is satisfied, and controlling the engine and the motor so as to start the engine and achieve the command power by using the engine and the motor after the engine starting condition is satisfied; and
changing the command power, at any point in time during a transition period from when the engine starting condition is satisfied to when the engine is started, so as to approach a value corresponding to the driving power, if a difference between the command power and the driving power is occurring or if the difference is expected to occur during the transition period.
